(19) United States
(12) Patent Application Publication
(10) Pub. No.: US 2026/0292667 A1
(43) Pub. Date: Sep. 24, 2026

(54) STANDALONE NON-PUBLIC NETWORK SELECTION BASED ON WIRELESS SIGNAL THRESHOLD

(71) Applicant: InterDigital Patent Holdings, Inc., Wilmington, DE (US)

(72) Inventors: Guanzhou Wang, Brossard (CA); Michael Starsinic, Newtown, PA (US); Saad Ahmad, Montreal (CA); Anuj Sethi, Ottawa (CA)

(73) Assignee: InterDigital Patent Holdings, Inc., Wilmington, DE (US)

(21) Appl. No.: 19/472,285

(22) PCT Filed: Apr. 5, 2024
(86) PCT No.: PCT/US2024/023177

§ 371 Date: Oct. 3, 2025

Related U.S. Application Data
(60) Provisional application No. 63/457,447, filed on Apr. 6, 2023.

(51) Int. Cl. H04W 48/18; H04B 17/309; H04W 60/00

(52) U.S. Cl. CPC H04W 48/18; H04B 17/309; H04W 60/00

(57) ABSTRACT

A wireless transmit/receive unit (WTRU) be used to provide Standalone Non-Public network (SNPN) selection based on a wireless signal threshold. The WTRU may receive configuration information, The configuration information may indicate one or more standalone non-public network (SNPN) identities and may indicate at least a received signal quality threshold. It may be determined that the WTRU supports a signal level enhanced network selection (SENSE) for an SNPN selection. A received signal may be measured when it is determined that the WTRU supports SENSE for the SNPN selection. The received signal may be associated with an SNPN identity from one or more SNPN identities. A message may be sent to a network node when the received signal associated with the SNPN satisfies the received signal quality threshold. The message may indicate a request to register the WTRU with the SNPN identity.

### CROSS-REFERENCE TO RELATED APPLICATIONS

The application claims the benefit of U.S. Provisional Application 63/457,447, filed Apr. 6, 2023, the contents of which are incorporated by reference in their entirety herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and apparatus are described herein for providing Standalone Non-Public network (SNPN) selection based on a wireless signal threshold.

A wireless transmit/receive unit (WTRU) be used to provide a Standalone Non-Public network (SNPN) selection based on a wireless signal threshold. A WTRU may receive configuration information. The configuration information may indicate one or more standalone non-public network (SNPN) identities and may indicate at least a received signal quality threshold. It may be determined that the WTRU supports a signal level enhanced network selection (SENSE) for an SNPN selection. A received signal may be measured when it is determined that the WTRU supports SENSE for the SNPN selection. The received signal may be associated with an SNPN identity from one or more SNPN identities. A message may be sent to a network node when the received signal associated with the SNPN satisfies the received signal quality threshold. The message may indicate a request to register the WTRU with the SNPN identity.

In an example, the received signal quality threshold may be at least one of received signal power (RSRP), reference signal received quality (RSRQ), or signal-to-interference-plus-noise ratio (SINR).

In an example, the configuration information may be determined by the processor of the WTRU by receiving a downlink (DL) non-access stratum (NAS) transport message, wherein the DL NAS transport message comprises a payload container type information element and wherein the payload container type information element indicates a WTRU parameter to update a transparent container.

In an example, the configuration information may be determined by retrieving it from a subscriber identity module (SIM),

In an example, the configuration information may further indicate an invalidity condition in which SENSE for the SNPN selection is not to be used. An example of an invalidity condition may be a location or time criterion. An example of an invalidity condition may be an identity of a service or an S-NSSAI.

In an example, if the received signal associated with the SNPN is greater than or equal to the received signal quality threshold, it satisfies the threshold.

In an example, a PLMN selection procedure may be started when the received signal associated with the SNPN is below the received signal quality threshold.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment,

FIG. 1D is a system diagram illustrating a further example RAN and a further example CN that may be used within the communications system illustrated in FIG. 1A according to an embodiment.

FIG. 2 shows an example of a method for providing enhanced automatic Standalone Non-Public network (SNPN) selection based on a signal quality threshold.

FIG. 3 shows another example of a method for providing enhanced automatic Standalone Non-Public network (SNPN) selection based on a signal quality threshold.

FIG. 4 shows an example method for providing enhanced SNPN selection for access using a Credential Holder's (CH) credentials.

### DETAILED DESCRIPTION

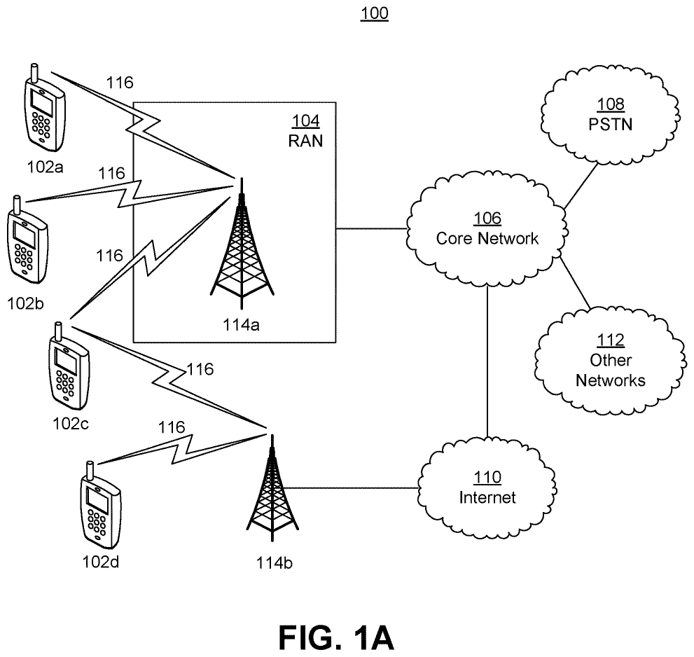

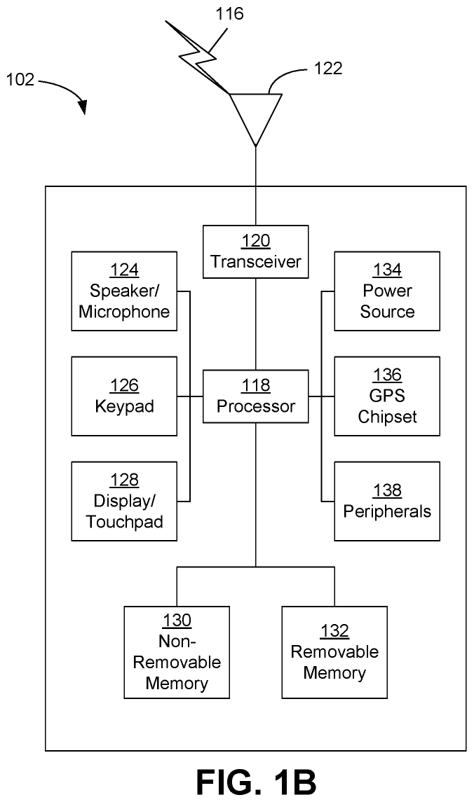

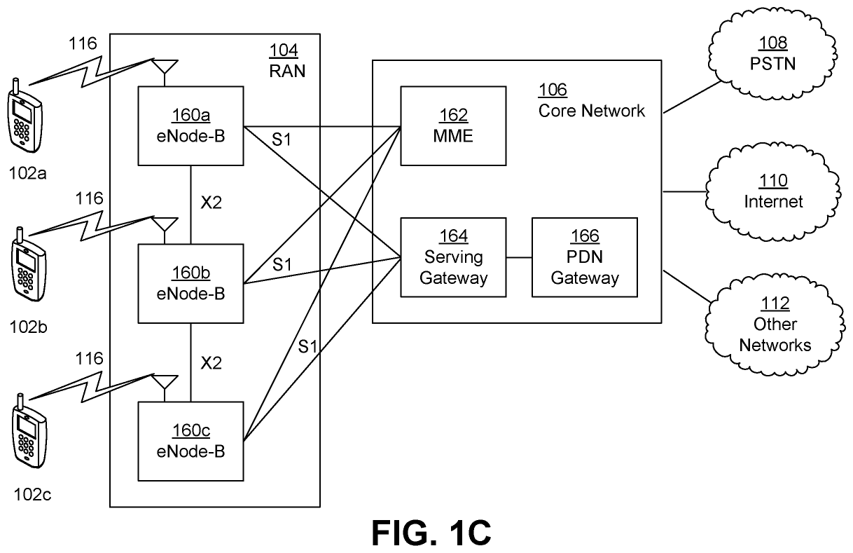

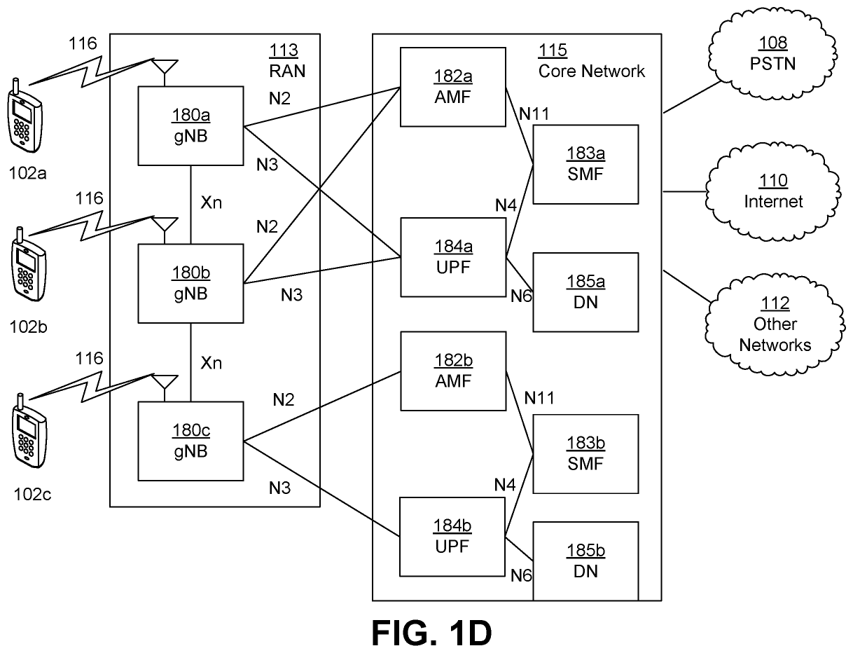

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station and/or a STA, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WIMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown In FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram Illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air Interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NIZn), nickel metal hydride (NIMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like, The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUS 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an ad-hoc mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS,

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 1800, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WIFI.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 1800 in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to a time, a time period, a tracking of time, a tracking of a period of time, a combination thereof, and/or the like. Reference to a timer expiration herein may refer to determining that the time has occurred or that the period of time has expired.

Systems, methods, and apparatus are described herein for providing a Standalone Non-Public network (SNPN) selection based on a wireless signal threshold.

Embodiments disclosed herein may be associated with a Non-Public Network. Embodiments disclosed herein may provide Signal level Enhanced Network Selection (SENSE). SNPN selection procedure(s) may be provided. Selection mode switching between SNPN/Public Land Mobile Networks (PLMNs) may be provided.

A subscribed SNPN may be associated with a signal level threshold. It may be qualified for network selection, for example, if the measured signal quality may be above the threshold.

Preferred SNPN for access using a credential holder's (CH's) credentials may be associated with a signal level threshold. An SNPN may be qualified for network selection, for example, if the measured signal quality is above the threshold. In examples, the WTRU may switch between SNPN selection mode, and normal PLMN selection mode (e.g., based on whether there is a qualified candidate network). This may depend on the signal level threshold.

The WTRU may receive configuration information indicating (e.g. be configured with) conditions to detect if (e.g., when) the SENSE feature may be applicable. The WTRU may be configured to know whether the SENSE feature may be applied in manual selection mode.

In examples, a SENSE feature may be applied for SNPN Access. A WTRU may perform a number of procedures and/or actions. A WTRU may be configured with information that may include SNPN Identities. The information may include a received signal quality threshold for an SNPN identity (e.g., each SNPN identity). The received signal quality threshold may be at least one of an RSRP, RSRQ, or SINR. The Information may be received in a message (e.g., DL NAS Transport message), for example, with an information element (e.g., with the payload container type information element) set to indicate a parameter, such as WTRU parameters update transparent container. The information may be stored in a subscriber identity module (SIM).

In examples, the information may include SENSE Invalidity Conditions that may indicate one or more conditions under which the SENSE feature may not be considered applicable. When indicated, the SENSE feature may be considered not applicable. This may indicate (e.g., mean) that the received signal quality threshold may be refrained from being considered (e.g., not be considered) in an SNPN selection procedure. The SENSE Invalidity Conditions may indicate location criteria or time criteria that may trigger the WTRU to disable the SENSE feature. The SENSE Invalidity Conditions may indicate that the WTRU may disable the SENSE feature, for example, if (e.g., when) the WTRU determines to access a particular service. The service may be identified by an S-NSSAI. The SENSE Invalidity Conditions may indicate that the WTRU may allow a user to disable the SENSE feature (e.g., via a GUI),

The information may indicate whether the SENSE feature may be applied when the WTRU may be in manual network selection mode. Applying the SENSE feature when the WTRU may be in manual network selection mode may indicate (e.g., mean) that the WTRU does not display detected PLMNs whose signal quality measurement may be lower than the operator-controlled signal threshold per access technology.

In examples, a WTRU may perform an SNPN selection procedure and select an SNPN on the condition that a signal quality measurement that may be associated with the SNPN may be greater than or equal to the received signal quality threshold (e.g., that was received in the configuration information).

In examples, a WTRU may perform an SNPN selection procedure. The WTRU may determine a measurement for one or more SNPNs. The WTRU may determine that none of the measurement(s) (e.g., zero measurements) are greater than or equal to the signal quality measurement threshold that may be configured for the SNPNs. Based on this determination, the SNPN selection procedure may be stopped and a PLMN Selection Procedure may start.

In examples, the WTRU may trigger the SNPN selections procedure (e.g., again), based on detecting that a measurement, associated with one or more SNPNs, may be greater than or equal to the signal quality measurement threshold, configured for the SNPNs.

A wireless transmit/receive unit (WTRU) may be used to provide a Standalone Non-Public network (SNPN) selection based on a wireless signal threshold. The configuration information may indicate one or more standalone non-public network (SNPN) identities and may indicate at least a received signal quality threshold. It may be determined that the WTRU supports a signal level enhanced network selection (SENSE) for an SNPN selection. A received signal may be measured, for example, If (e.g., when) it is determined that the WTRU supports SENSE for the SNPN selection. The received signal may be associated with an SNPN identity from one or more SNPN identities. A message may be sent to a network node when the received signal associated with the SNPN satisfies the received signal quality threshold. The message may indicate a request to register the WTRU with the SNPN identity.

In an example, the received signal quality threshold may include one or more of a received signal power (RSRP), reference signal received quality (RSRQ), or signal-to-interference-plus-noise ratio (SINR).

In examples, the configuration information may be determined by the processor of the WTRU by receiving a message (e.g., downlink (DL) non-access stratum (NAS) transport message). The message (e.g., DL NAS transport message) may include (e.g., comprise) a payload container type information element. The payload container type information element may indicate a WTRU parameter, for example, to update a transparent container.

In examples, the configuration information may be determined by retrieving it from a subscriber identity module (SIM).

In examples, the configuration information may further indicate an Invalidity condition in which SENSE for the SNPN selection may be refrained from being used (e.g., is not to be used). An invalidity condition may include a condition associated with a location or time criterion. An invalidity condition may include a condition associated with an identity of a service or Single-Network Slice Selection Assistance Information (S-NSSAI).

In examples, if the received signal associated with the SNPN is greater than or equal to the received signal quality threshold, the signal may satisfy the threshold.

In examples, a PLMN selection procedure may be started if (e.g., when) the received signal associated with the SNPN is below the received signal quality threshold.

Signal level Enhanced Network Selection (SENSE) may be used (e.g., by the home operator) to configure certain WTRUs to take the signal quality (e.g., RSRP, RSRQ, SINR, etc.) into account during the network selection process. This enhancement may be used if (e.g., when) stationary (e.g., certain stationary) IoT devices that are in a roaming situation (e.g., deployed in a foreign country, deployed in a place with poor network coverage, etc.) are experiencing frequent failure connecting to the visiting PLMN (VPLMN), These devices may be stationary and unable to move around to improve the radio condition. They may be in a roaming situation (e.g., a permanent roaming situation) that may make it difficult (e.g., almost impossible) to select a different VPLMN according to the PLMN selection rules. By considering signal quality, the WTRU may select a network with better radio conditions though it may be of lower priority in the network selection order.

The home network operator may configure the USIM with an operator controlled signal threshold per access technology. The operator controlled signal threshold per access technology may be specific for an access technology (e.g., a certain access technology) and may apply to one or more PLMNs with the corresponding access technology combination. The WTRU may consider (e.g., only consider) those candidate PLMNs whose signal quality may be equal to or greater than the configured threshold.

The enhancement may apply to PLMN selection and one or more WTRU types (e.g., WTRUs supporting NB-IoT, Category M1 or M2 of E-UTRA, etc.). For example, the same issue may exist for stationary WTRUs that may be served by SNPNs. For example, a WTRU in SNPN selection mode may consider the last registered SNPN as a high priority (e.g., the highest priority in SNPN selection). The stationary WTRU may suffer frequent connection failures and may have few opportunities to change the condition without human intervention, for example, if the last registered SNPN has poor coverage in the WTRU's location.

The SNPN selection procedure may differ (e.g., very different) from PLMN selection (e.g., in a number of aspects). In examples, a WTRU may have multiple entries in its list of subscriber data for SNPN. An entry (e.g., each entry) may represent a subscribed SNPN. There may not be a priority order (e.g., an explicit priority order) among these multiple entries. A WTRU may select an entry. The WTRU may select an SNPN from the list of preferred SNPNs, for example, if the SNPN supports WTRU access to the SNPN using Credential Holder's credentials. There may be no roaming scenario in SNPN selection. The WTRU may select a subscribed SNPN or an SNPN using Credential Holder's credentials.

Described herein are systems, methods, and apparatus to enhance the SNPN selection procedure to consider the network signal quality.

One or more items may be considered to ensure a WTRU selects an SNPN that may provide a stable connection by taking the signal quality into account during the SNPN selection procedure. A WTRU may consider a received signal quality in selecting a subscribed SNPN if (e.g., when) multiple subscribed SNPNs are available. A WTRU may consider the received signal quality in selecting a preferred SNPN for access using CH's credentials if (e.g., when) multiple preferred SNPNs are available. A WTRU may consider the received signal quality in selecting between SNPN and PLMN or if (e.g., when) switching between SNPN selection mode and PLMN selection mode.

Details associated with a subscribed SNPN selection that considers received signal quality may be provided. For a WTRU that supports SNPN access, the WTRU may receive configuration information indicating (e.g., be pre-configured with or acquire, through a remote provisioning procedure) a list of subscriber data containing zero or more entries of Subscribed SNPNs. For a (e.g., each) Subscribed SNPN in the list, a received signal quality threshold (e.g., at least one of RSRP, RSRQ, or SINR) may be configured. The configuration information may be received in a message (e.g., DL NAS Transport message) with an information element (e.g., with the Payload container type information element) set to indicate WTRU parameters update transparent container. The setting of a signal quality threshold may be chosen by the service provider or SNPN operator. The setting of a signal quality threshold may consider the characteristics or requirements of the services provided in the network. For example, a higher signal quality threshold may be set for an SNPN that serves critical medical sensors and equipment. For example, a common signal quality threshold that applies to one or more (e.g., all) subscribed SNPNs may be configured.

A WTRU that supports SENSE in SNPN selection may consider (e.g., only consider) the one or more subscribed SNPNs in an automatic SNPN selection procedure. For example, the one or more subscribed SNPNs may be subscribed SNPNs, for which no signal quality threshold may be configured.

For example, the one or more subscribed SNPNs may be subscribed SNPNs, for which a signal quality threshold may be configured, and the received signal quality may be equal or above the threshold. If there are multiple Subscribed SNPNs that qualify according to the criteria described herein, the WTRU may consider the SNPNs with configured signal quality thresholds as having a higher priority than those without signal quality thresholds. The WTRU may choose the SNPN that has a high received signal quality (e.g., the highest received signal quality).

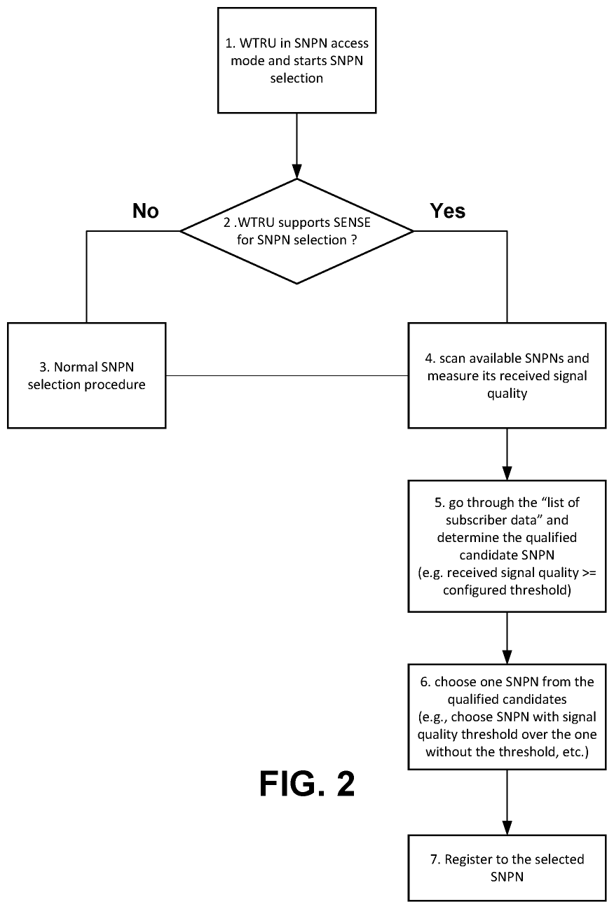

FIG. 2 shows an example of a method for providing enhanced automatic Standalone Non-Public network (SNPN) selection based on a signal quality threshold. FIG. 2 may show an enhanced automatic SNPN selection using a signal quality threshold.

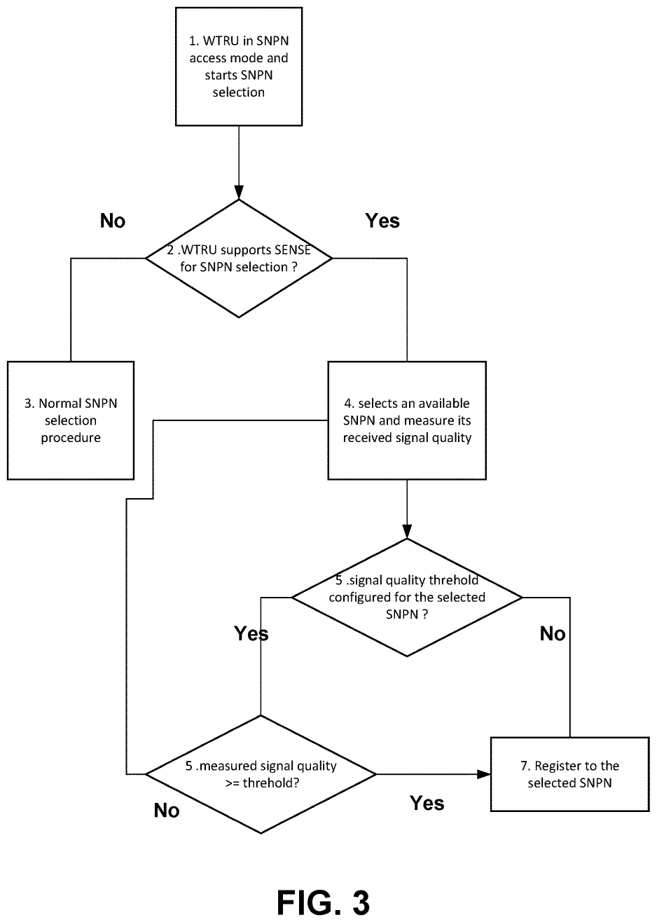

In examples (e.g., which may be an alternative to the example procedure in FIG. 2), the WTRU may select an available SNPN without measuring one or more (e.g., all) other available SNPN's signal quality. The WTRU may consider the SNPN as not available and may reselect another SNPN (e.g., as described in FIG. 3), for example, if the received signal quality of the selected SNPN is below the signal quality threshold (e.g., if configured).

FIG. 3 shows an example automatic Standalone Non-Public network (SNPN) selection based on a signal quality threshold. FIG. 3 illustrates an example enhanced automatic SNPN selection using signal quality threshold.

The WTRU may (re-)evaluate the received signal quality in the registered SNPN and may perform the SNPN selection (e.g., or reselection) procedure (e.g., as shown in FIG. 3) again, for example, if the received signal quality is below the configured signal quality threshold. The WTRU may re-evaluate the signal quality and may perform SNPN reselection periodically. The WTRU may re-evaluate the signal quality and may perform SNPN reselection, for example, if one or more connection failures have been observed in the registered network (e.g., radio link failure, high data block error rate, etc.). The WTRU may (re-)evaluate the signal quality and may perform SNPN reselection, for example, if the configured signal quality thresholds have been updated (e.g., through a NAS or SoR procedure).

SNPN selection for access using CH's credentials may be provided. The WTRU may be configured with a list of SNPNs (e.g., preferred SNPNs) for access using CH's credentials. The list may be associated with an SNPN subscription (e.g., an entry in the list of subscriber data) or a PLMN subscription. An SNPN subscription or a PLMN subscription may be selected (e.g., by the WTRU), The list of preferred SNPNs associated with the SNPN subscription or PLMN subscription may be used.

A signal quality threshold may be associated with a (e.g., each) SNPN identifier in the list of preferred SNPNs for accessing using CH's credentials. A signal quality threshold may be added as the extension of the validity condition, for example, for SNPNs in the list that may be (e.g., already) associated with a validity condition (e.g., time validity info). An SNPN may be considered as a qualified candidate, for example, (e.g., only) if the measured signal quality may be equal to or above the configured threshold (e.g., if the SNPN is associated with a signal threshold).

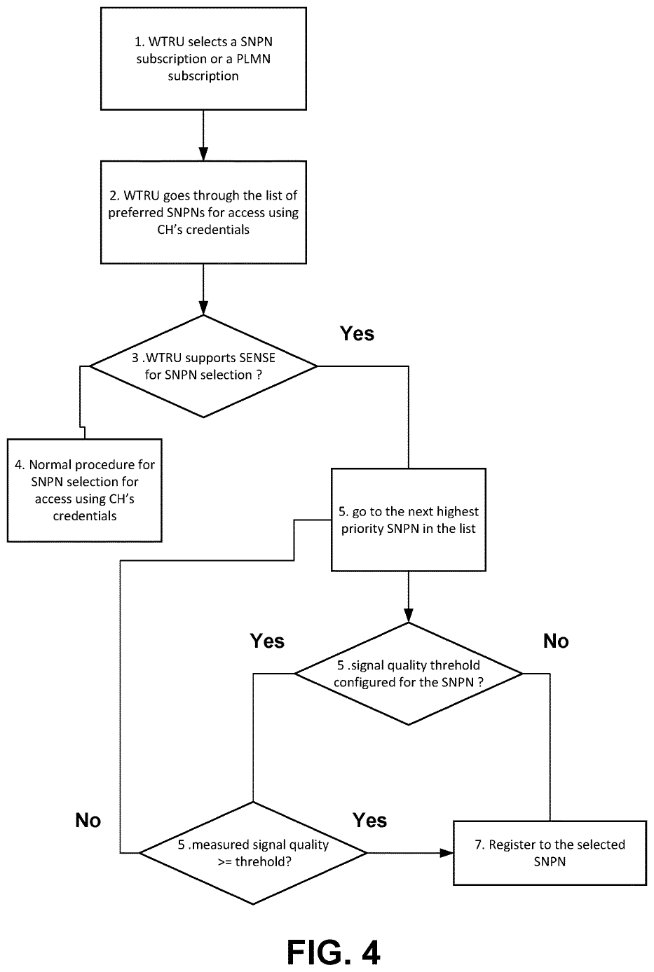

FIG. 4 shows an example of SNPN selection for access using a Credential Holder's (CH) credentials. For example, FIG. 4 illustrates an example SNPN selection procedure for access using CH's credentials that may consider the signal quality.

Switching between an SNPN selection mode and a PLMN selection mode may be provided. a WTRU may exit SNPN selection mode to be able to select a PLMN (e.g., if it has PLMN subscription), for example, if the WTRU is in an SNPN selection mode, if the WTRU supports SENSE, and there is no qualified SNPN for SNPN selection (e.g., the received signal quality of the candidate SNPNs may be lower than the configured signal quality threshold). For example, the WTRU may (e.g., be able to) register with a PLMN and access the SNPN services (e.g., through the N3IWF of the SNPN) from the PLMN. The WTRU may (e.g., be able to) periodically check if there is a (e.g., any) qualified SNPN available, for example, if (e.g., when) the WTRU is registered in the PLMN. For example, there may be a candidate subscribed SNPN for which the measured signal quality may be equal or greater than the configured threshold), The WTRU may (e.g., be able to) switch back to SNPN selection mode and select a qualified SNPN, for example, if there is a (e.g., one or more) qualified SNPN available.

The WTRU may switch to SNPN selection mode to be able to select an SNPN (e.g., if it has an SNPN subscription), for example, if a WTRU is in PLMN selection mode and supports SENSE and there is no qualified PLMN for PLMN selection (e.g., the received signal quality of the candidate PLMN is lower than the configured signal quality threshold). For example, the WTRU may register with an SNPN and access the PLMN services (e.g., through the N3IWF of the PLMN) from the SNPN. The WTRU may check (e.g., periodically check) if a (e.g., any) qualified PLMN is available, for example if (e.g., when) the WTRU is registered in the SNPN. For example, there may be a candidate PLMN for which the measured signal quality may be equal to or greater than the configured threshold. The WTRU may switch back to SNPN selection mode and select a qualified PLMN, for example, if one or more qualified PLMNs are available.

As the signal quality may change quickly, if (e.g., when) the WTRU(e.g., while operating in the PLMN/SNPN selection mode), discovers SNPNs/PLMNs with signal quality above the threshold set by the operator, the WTRU may ensure that the signal quality of the discovered SNPNs/PLMNs are above the threshold for a given period of time (e.g., average signal value), before making the switch from PLMN/SNPN selection mode to SNPN/PLMN selection mode. This may be to ensure that the WTRU is not ping-ponging between SNPN and PLMN selection modes. An operator may set the WTRU to be configured with the period of time, for example, if (e.g., when) it is configured with the signal quality threshold.

If (e.g., when) to disable the SENSE feature may be determined. A WTRU that supports the SENSE feature may use a signal quality measurement to determine if a PLMN/access technology combination may be a selection candidate.

There may be scenarios where the WTRU determines that the SENSE feature may be not applicable or may be disabled.

The WTRU may stop applying the SENSE feature and may attempt the network selection procedure (e.g., as if the SENSE feature is not applicable), for example, (e.g., as described herein) if (e.g., when) the WTRU detects that the received signal quality from none of the candidate PLMN(s) or PLMN/access technology combination(s) is equal to or greater than the operator controlled signal threshold per access technology stored in the USIM.

In examples, the SENSE feature may be disabled (e.g., it may be advantageous to disable) based on different conditions. The home network operator may request that the WTRU refrain from applying (e.g., not apply) the SENSE feature in certain countries so that the WTRU may be more likely to select roaming partners (e.g., PLMNs) that are preferred by the home network operator. It may be desirable to disable the SENSE feature for a particular SNPN, for example, because the SNPN may provide access to a specific service that may not be obtained via a different SNPN. A system (e.g., such as the 5G System) may not support a means for disabling the SENSE feature under certain conditions or for certain SNPNs.

The WTRU may be configured with SENSE Invalidity Conditions, for example, if (e.g., when) a WTRU is configured with an operator controlled signal threshold per access technology. The operation configuring the WTRU with an operator controlled signal threshold per access technology may configure the WTRU with SENSE Invalidity Conditions. The SENSE Invalidity Conditions may be stored in the USIM with the Operator controlled signal threshold per access technology. The SENSE Invalidity Conditions may indicate one or more conditions under which the SENSE feature may not be applicable.

For example, the SENSE Invalidity Conditions may indicate to the WTRU that the SENSE feature may be disabled when the WTRU is in a certain location (e.g., a country). For example, this may be done when the home network operator desires to increase the likelihood of the WTRU selecting particular networks when the WTRU is located in certain locations.

For example, the SENSE Invalidity Conditions may indicate to the WTRU that the SENSE feature may be disabled, for example, at certain times (e.g., between 12:00 PM and 7:00 PM). For example, this may be done when the home network operator wants to decrease the likelihood of the WTRU selecting particular networks when the network is typically busy.

The SENSE Invalidity Conditions may indicate to the WTRU that the SENSE feature may be disabled if (e.g., when) the WTRU wants to access particular services. For example, the SENSE Invalidity Conditions may include one or more S-NSSAI(s), and the WTRU may consider disabling the feature if it plans on attempting to register to one or more of the indicated S-NSSAI(s). For example, this may be done when the home network operator desires to decrease the likelihood of the WTRU selecting particular networks when accessing certain S-NSSAIs.

The SENSE Invalidity Conditions may indicate to the WTRU that the SENSE feature may be disabled if (e.g., when) the user disables the feature. The terminal equipment (TE) part of the WTRU may host an application, such as a GUI. The application may allow the user to indicate that the SENSE feature may be disabled. The application may be triggered to send a message to the mobile terminal (MT) part of the WTRU to request that the SENSE feature be disabled, for example, if (e.g., when) the user indicates that the SENSE feature may be disabled. The message may be an attention (AT) Command, such as an enhanced version of the +COPS command. The MT may respond with a confirmation that the feature may be disabled, for example, if the SENSE Invalidity Conditions indicate that the user may disable the feature. The MT may respond with an indication that the feature may not be disabled, for example, if the SENSE Invalidity Conditions indicate that the user may not disable the feature (e.g., it may not be included in the SENSE Invalidity Conditions). The GUI display that may be selected by the user may read, search for, and select a network regardless of signal quality and/or the like, for example, if (e.g., when) the user disables the feature,.

As described above, the WTRU (WTRU) may be configured with a signal threshold per access technology for a (e.g., each) SNPN that it may be subscribed to. A WTRU may be configured with a SENSE invalidity condition for an (e.g., each) SNPN to which it may be subscribed. The WTRU may be configured to detect conditions if (e.g., when) the SENSE feature may be disabled for certain SNPNs. For example, this may be done in scenarios where the WTRU may be able to obtain the service from multiple SNPNs when it may be in one location but may not be able to obtain the service from multiple SNPNs when it may be in another location.

Some examples described herein show how a WTRU may be configured to detect when the SENSE feature is not applicable. Those examples may demonstrate how a WTRU may be configured similarly to detect when the SENSE feature may be applicable.

Applying the SENSE feature during manual selection may be provided.

A WTRU may determine that the SENSE feature may be applied when the WTRU is in manual selection mode.

The SENSE invalidity conditions described above may indicate whether the SENSE feature may be applied when the WTRU is in manual network selection mode.

Applying the SENSE feature if (e.g., when) the WTRU is in manual network selection mode may indicate (e.g., mean) that the WTRU may refrain from displaying (e.g., may not display) detected PLMNs whose signal quality measurement may be lower than the operator controlled signal threshold per access technology. For example, when the SENSE feature may be disabled, and the +COPS AT Command may be invoked, the MT response to the +COPS AT command may refrain from including (e.g., may not include) PLMNs whose signal quality measurement may be lower than the Operator controlled signal threshold per access technology. Alternatively, the MT response to the +COPS AT command may include PLMNs whose signal quality measurement may be lower than the Operator controlled signal threshold per access technology and may include an indication that their signal quality measurement may be low or below the Operator controlled signal threshold per access technology. PLMNs may be displayed to the user along with an indication that the signal strength of the PLMNs may be low, for example, if (e.g., when) the PLMNs whose signal quality measurement are lower than the Operator controlled signal threshold per access technology are included in the message to the TE. The user may manually select a network after considering the available network and considering which networks are associated with low signal strengths. This selection by the user may be performed via a GUI.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU), the WTRU comprising:
a processor configured to:
determine configuration information, wherein the configuration information indicates one or more standalone non-public network (SNPN) identities and indicates at least a received signal quality threshold;
determine that the WTRU supports signal level enhanced network selection (SENSE) for an SNPN;
based on the determination that the WTRU supports SENSE for the SNPN, measure a received signal, wherein the received signal is associated with an SNPN identity from the one or more SNPN identities;
determine whether the received signal associated with the SNPN identity satisfies the received signal quality threshold; and
based on a determination that the received signal associated with the SNPN identity satisfies the received signal quality threshold, send a message to a network node, wherein the message indicates a request to register the WTRU with the SNPN identity.

2. The WTRU of claim 1, wherein the received signal quality threshold is at least one of a received signal power (RSRP), a reference signal received quality (RSRQ), or signal-to-interference-plus-noise ratio (SINR).

3. The WTRU of claim 1, wherein the received signal associated with the SNPN identity is determined to satisfy the received signal quality threshold based on a determination that the received signal is greater than or equal to the received signal quality threshold.

4. The WTRU of claim 1, wherein the SNPN identity is a first SNPN identity, wherein the message is a first message, wherein the received signal quality threshold is a first received signal quality threshold associated with the first SNPN identity, wherein the received signal is a first received signal, wherein the configuration information further indicates a second received signal quality threshold associated with a second SNPN identity, and wherein the processor is further configured to:
measure a second received signal, wherein the second received signal is associated with the second SNPN identity from the one or more SNPN identities;
determine whether the second received signal associated with the second SNPN identity satisfies the second received signal quality threshold associated with the second SNPN identity; and
based on a determination that the second received signal associated with the second SNPN identity satisfies the second received signal quality threshold, send a second message to a network node, wherein the second message indicates a request to register the WTRU with the second SNPN identity.

5. The WTRU of claim 1, wherein the processor is further configured to:
receive a downlink (DL) non-access stratum (NAS) transport message, wherein the DL NAS transport message comprises an information element that indicates a WTRU parameter associated with updating a transparent container, and wherein the configuration information is determined based on the received DL NAS transport message.

6. The WTRU of claim 1, wherein the processor is further configured to:
obtain the configuration information from a subscriber identity module (SIM).

7. The WTRU of claim 1, wherein the configuration information further indicates an invalidity condition associated with whether SENSE for the SNPN is supported.

8. The WTRU of claim 7, wherein the invalidity condition is associated with one or more of a location, a time, an identity of a service, or a single-network slice selection assistance information (S-NSSAI).

9. The WTRU of claim 1, wherein the processor is further configured to:
based on a determination that the received signal associated with the SNPN identity is below the received signal quality threshold, determine to initiate a public land mobile network (PLMN) selection procedure.

10. The WTRU of claim 9, wherein the determination to initiate the PLMN selection procedure is based on a determination that the WTRU supports PLMN subscription.

11. A method, the method comprising:
determining configuration information, wherein the configuration information indicates one or more standalone non-public network (SNPN) identities and indicates at least a received signal quality threshold;
determining that the WTRU supports signal level enhanced network selection (SENSE) for an SNPN;
based on the determination that the WTRU supports SENSE for the SNPN, measuring a received signal, wherein the received signal is associated with an SNPN identity from the one or more SNPN identities;
determining whether the received signal associated with the SNPN identity satisfies the received signal quality threshold; and
based on a determination that the received signal associated with the SNPN identity satisfies the received signal quality threshold, sending a message to a network node, wherein the message indicates a request to register the WTRU with the SNPN identity.

12. The method of claim 11, wherein the received signal quality threshold is at least one of a received signal power (RSRP), a reference signal received quality (RSRQ), or signal-to-interference-plus-noise ratio (SINR).

13. The method of claim 11, wherein the received signal associated with the SNPN identity is determined to satisfy the received signal quality threshold based on a determination that the received signal is greater than or equal to the received signal quality threshold.

14. The method of claim 11, wherein the SNPN identity is a first SNPN identity, wherein the message is a first message, wherein the received signal quality threshold is a first received signal quality threshold associated with the first SNPN identity, wherein the received signal is a first received signal, wherein the configuration information further indicates a second received signal quality threshold associated with a second SNPN identity, and wherein the method further comprises:
measuring a second received signal, wherein the second received signal is associated with the second SNPN identity from the one or more SNPN identities;
determining whether the second received signal associated with the second SNPN identity satisfies the second received signal quality threshold associated with the second SNPN identity; and
based on a determination that the second received signal associated with the second SNPN identity satisfies the second received signal quality threshold, sending a second message to a network node, wherein the second message indicates a request to register the WTRU with the second SNPN identity.

15. The method of claim 11, wherein the method further comprises:
receiving a downlink (DL) non-access stratum (NAS) transport message, wherein the DL NAS transport message comprises an information element that indicates a WTRU parameter associated with updating a transparent container, and wherein the configuration information is determined based on the received DL NAS transport message.

16. The method of claim 11, wherein the method further comprises:
obtaining the configuration information from a subscriber identity module (SIM).

17. The method of claim 11, wherein the configuration information further indicates an invalidity condition associated with whether SENSE for the SNPN is supported.

18. The method of claim 17, wherein the invalidity condition is associated with one or more of a location, a time, an identity of a service, or a single-network slice selection assistance information (S-NSSAI).

19. The method of claim 11, wherein the method further comprises:
based on a determination that the received signal associated with the SNPN identity is below the received signal quality threshold, determining to initiate a public land mobile network (PLMN) selection procedure.

20. The method of claim 19, wherein the determination to initiate the PLMN selection procedure is based on a determination that the WTRU supports PLMN subscription.
